(19) United States
(12) Patent Application Publication
(10) Pub. No.: US 2012/0281500 A1
(43) Pub. Date: Nov. 8, 2012

(54) INTERACTION WITH SEISMIC DATA

(75) Inventor: Edo Hoekstra, Hafrsfjord (NO)

(73) Assignee: SCHLUMBERGER TECHNOLOGY CORPORATION, HOUSTON, TX (US)

(21) Appl. No.: 13/098,605

(22) Filed: May 2, 2011

(51) Int. Cl. G01V 1/34; G09G 5/00

(52) U.S. Cl. 367/68; 345/619

(57) ABSTRACT

One or more computer-readable media including computer-executable instructions to instruct a computing device to format multidimensional data, with respect to one or more dimensions of a multidimensional coordinate system, responsive to receipt of a first linear motion signal from manipulation of an input device; format multidimensional data, with respect to one or more dimensions of a multidimensional coordinate system, responsive to receipt of a second linear motion signal from manipulation of an input device where the first linear motion and second linear motion are orthogonal motions; format multidimensional data, with respect to one or more dimensions of a multidimensional coordinate system, responsive to receipt of a first rotational motion signal from manipulation of an input device; and format multidimensional data, with respect to one or more dimensions of a multidimensional coordinate system, responsive to receipt of a second rotational motion signal from manipulation of an input device where the first rotational motion and the second rotational motion are clockwise and counter-clockwise motions. Various other apparatuses, systems, methods, etc., are also disclosed.

### BACKGROUND

Displaying and manipulating seismic sections is one of the core activities of geoscience screening and interpretation workflows. Interaction with seismic sections is typically performed using panning and section player controls, initiated via a conventional human interface device like a mouse or a keyboard. As described herein, various technologies and techniques can facilitate screening, interpretation, etc., of seismic or other data.

### SUMMARY

One or more computer-readable media including computer-executable instructions to instruct a computing device to format multidimensional data, with respect to one or more dimensions of a multidimensional coordinate system, responsive to receipt of a first linear motion signal from manipulation of an input device; format multidimensional data, with respect to one or more dimensions of a multidimensional coordinate system, responsive to receipt of a second linear motion signal from manipulation of an input device where the first linear motion and second linear motion are orthogonal motions; format multidimensional data, with respect to one or more dimensions of a multidimensional coordinate system, responsive to receipt of a first rotational motion signal from manipulation of an input device; and format multidimensional data, with respect to one or more dimensions of a multidimensional coordinate system, responsive to receipt of a second rotational motion signal from manipulation of an input device where the first rotational motion and the second rotational motion are clockwise and counter-clockwise motions. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example system that includes various components for simulating a reservoir;

FIG. 2 illustrates examples of various input devices;

FIG. 3 illustrates examples of scenarios of manipulating seismic data;

FIG. 4 illustrates examples of tracking spatial information in seismic data;

FIG. 5 illustrates an example of a method tracking a feature in seismic data;

FIG. 6 illustrates examples of manipulating time-based seismic data;

FIG. 7 illustrates an example of a method that includes rendering data for a selected time or time difference;

FIG. 8 illustrates an example of a system and an example of a method for rendering data;

FIG. 9 illustrates examples of recording and playback of data and associated graphical user interfaces;

FIG. 10 illustrates examples of rotating a plane about an axis and an example of a method for selecting an axis;

FIG. 11 illustrates an example of selecting a fourth dimension and an example of a method; and

FIG. 12 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

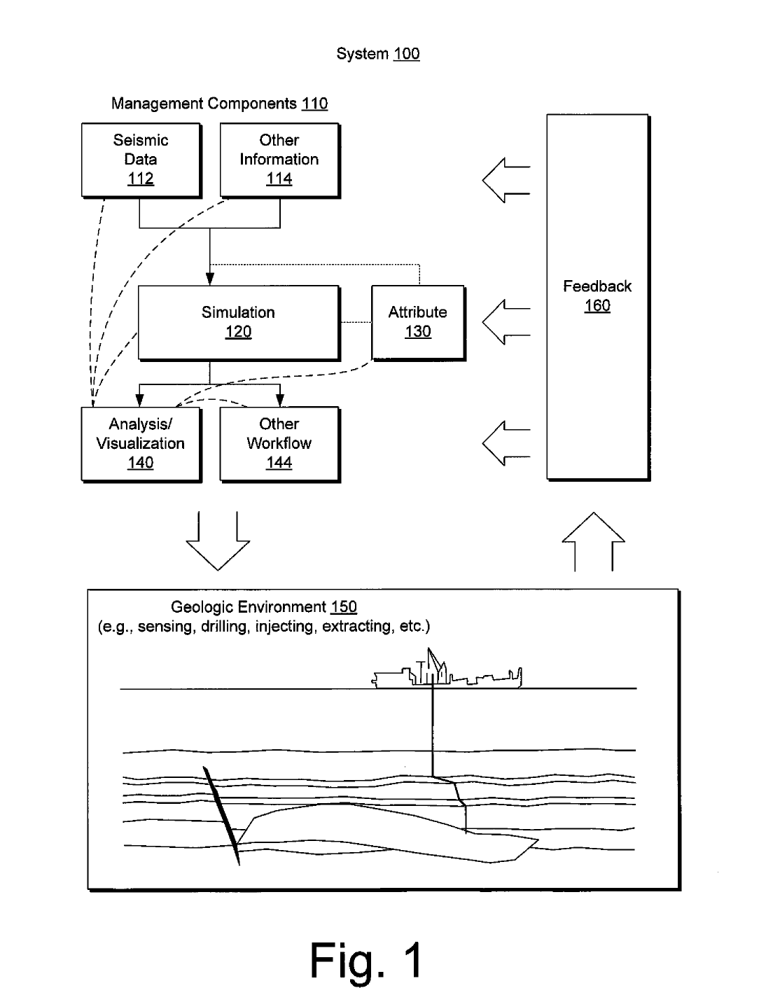

FIG. 1 shows an example of a system 100 that includes various management components 110 to manage various aspects of a geologic environment 150. For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an information component 114, a processing component 116, a simulation component 120, an attribute component 130, an analysis/visualization component 140 and a workflow component 144. In operation, seismic data and other information provided per the components 112 and 114 may be input to the simulation component 120.

The simulation component 120 may process information to conform to one or more attributes, for example, as specified by the attribute component 130, which may be a library of attributes. Such processing may occur prior to input to the simulation component 120. Alternatively, or in addition to, the simulation component 120 may perform operations on input information based on one or more attributes specified by the attribute component 130. As described herein, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 140 may allow for interaction with data (e.g., via the data component 112 or other information component 114), a simulation of the simulation component 120, one or more attributes of the attribute component 130, model-based results, etc. Additionally, or alternatively, output from the simulation component 120 may be input to one or more other workflows, as indicated by a workflow component 144.

Various technologies and techniques are described herein for analysis and visualization of information. In the example of FIG. 1, the component 140 may include subcomponents, optionally for interaction with one or more of the other management components 110. For example, the component 140 may allow for analysis and visualization of seismic data via the seismic data component 112 prior to simulation by the simulation component 120. The component 140 may rely on or include graphics processing capabilities, for example, graphics accelerator hardware, graphics processing framework software (consider, e.g., application programming interfaces such as those of DIRECTX®, Microsoft Corporation, Redmond, Wash.), etc. The component 140 may include one or more subcomponents for receipt of user input instructions, for example, for compatibility with hardware input, software input or a combination of hardware and software input.

As described herein, the management components 110 may include features of a commercially available simulation framework such as the PETREL® seismic to simulation software framework (Schlumberger Limited, Houston, Tex.). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes.

As described herein, the management components 110 may include features for geology and geological modeling to generate high-resolution geological models of reservoir structure and stratigraphy (e.g., classification and estimation, facies modeling, well correlation, surface imaging, structural and fault analysis, well path design, data analysis, fracture modeling, workflow editing, uncertainty and optimization modeling, petrophysical modeling, etc.). Particular features may allow for performance of rapid 2D and 3D seismic interpretation, optionally for integration with geological and engineering tools (e.g., classification and estimation, well path design, seismic interpretation, seismic attribute analysis, seismic sampling, seismic volume rendering, geobody extraction, domain conversion, etc.). As to reservoir engineering, for a generated model, one or more features may allow for simulation workflow to perform streamline simulation, reduce uncertainty and assist in future well planning (e.g., uncertainty analysis and optimization workflow, well path design, advanced gridding and upscaling, history match analysis, etc.). The management components 110 may include features for drilling workflows including well path design, drilling visualization, and real-time model updates (e.g., via real-time data links).

As described herein, various aspects of the management components 110 may be add-ons or plug-ins (e.g., executable code) that operate according to specifications of a framework environment. For example, a commercially available framework environment marketed as the OCEAN® framework environment (Schlumberger Limited) allows for seamless integration of add-ons (or plug-ins) into a PETREL® framework workflow. The OCEAN® framework environment leverages .NET® tools (Microsoft Corporation, Redmond, Wash.) and offers stable, user-friendly interfaces for efficient development. As described herein, various components may be implemented as add-ons (or plug-ins) that conform to and operate according to specifications of a framework environment (e.g., according to application programming interface (API) specifications, etc.). Various technologies described herein may be optionally implemented as components in an attribute library.

In the field of seismic analysis, aspects of a geologic environment may be defined as attributes. In general, seismic attributes help to condition conventional amplitude seismic data for improved structural interpretation tasks, such as determining the exact location of lithological terminations and helping isolate hidden seismic stratigraphic features of a geologic environment. Attribute analysis can be quite helpful to defining a trap in exploration or delineating and characterizing a reservoir at the appraisal and development phase. An attribute generation process (e.g., in the PETREL® framework or other framework) may rely on a library of various seismic attributes (e.g., for display and use with seismic interpretation and reservoir characterization workflows). At times, a need or desire may exist for generation of attributes on the fly for rapid analysis. At other times, attribute generation may occur as a background process (e.g., a lower priority thread in a multithreaded computing environment), which can allow for one or more foreground processes (e.g., to enable a user to continue using various components).

Attributes can help extract the maximum amount of value from seismic and other data, for example, by providing more detail on subtle lithological variations of a geologic environment (e.g., an environment that includes one or more reservoirs).

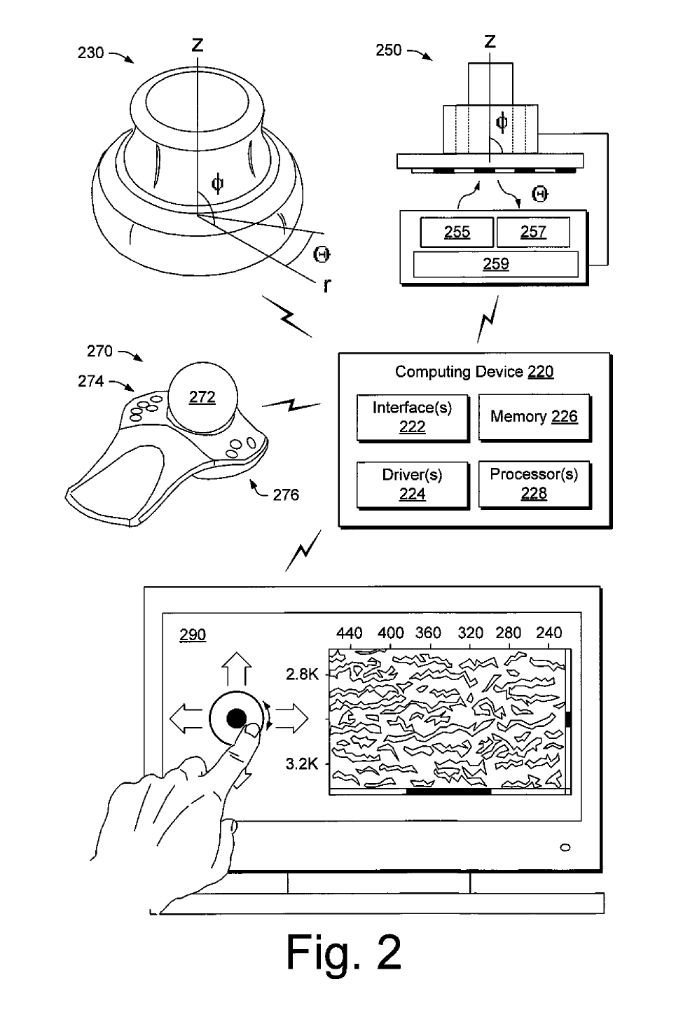

FIG. 2 shows various examples of input devices 230, 250, 270 and 290 along with an example of a computing device 220. The example computing device 220 includes one or more interfaces 222, one or more drivers 223, memory 226 and one or more processors 228. As described herein, such a device may include one or more processors and memory for performing graphics operations (e.g., one or more GPUs). Graphics operations may include manipulation of multidimensional data, analysis of multidimensional data, etc., and optionally rendering data or, more generally, information to a display device. As described herein, various techniques may be used to manipulate, analyze, manipulate and analyze seismic or other geoscience data using features of a graphics framework. For example, where a reservoir simulation model includes cells with cell information, such cells and cell information may be treated as voxels and voxel information as associated with a 3D graphics application (e.g., programming in a shader language or other GPU language or framework language may allow for manipulation or analysis of seismic or other geoscience data).

The input device 230 may be a so-called “3D” mouse, for example, the 3DCONNEXION® SPACE NAVIGATOR™ device marketed by 3Dconnexion GmbH, Munich, Germany, which provides for manipulation of 3D graphics applications (e.g., cooperatively with a conventional mouse) to perform zooming (e.g., shifting z-axis a direction linearly in re plane), panning left/right (e.g., shifting z-axis a direction linearly in re plane), panning up/down (e.g., pulling up along z-axis or pushing down along z-axis), tilting (e.g., linear direction tilt over angle φ), spinning (e.g., angle Θ) and rolling (e.g., linear direction tilt over angle φ). As a use example, one hand may engage the input device 230 to position a 3D graphics application model or navigate a 3D graphics application environment while the other hand simultaneously uses a conventional mouse to select, create or edit. As described herein, other input devices marketed by 3DConnexion GmbH (e.g., SpaceExplorer device, etc.) or others may optionally be suitable for input.

The input device 250 may include an emitter 255, a detector 257 and circuitry 259 for processing and output. As shown, the device 250 may allow for tilt input along a z-axis, as well as spinning about the z-axis.

The input device 270 may include a ball 272 such as a roller ball as well as various buttons 272 and 274 for user input. Such a device may include a software driver that can call for rendering of a graphical user interface that allows for user configuration of the buttons.

The input device 290 may be a touch screen that operates in conjunction with one or more graphical user interfaces. A graphical user interface may include a control dial and control arrows or other controls that allow for user input, for example, equivalent to or akin to user input received via a hardware device. As shown with respect to the input device 290, features such as slider bars, etc., may be provided as graphics controls.

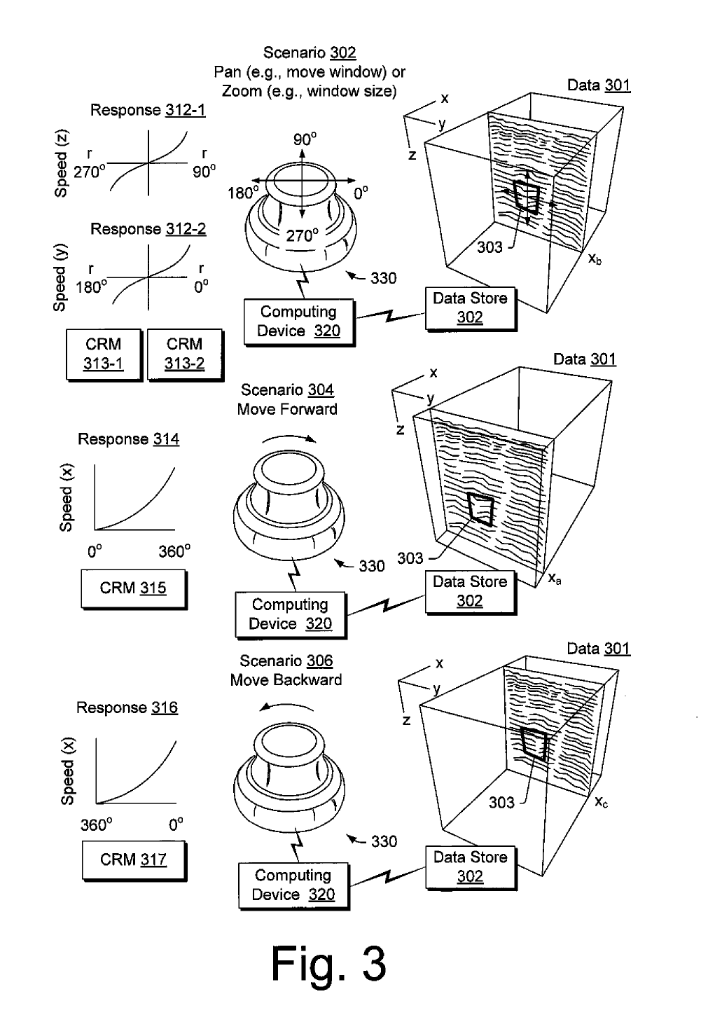

FIG. 3 shows three example scenarios 302, 304 and 306 for manipulating data 301. In each of the scenarios, a computing device 320 is shown as being configured to receive motion signals from an input device 330 as well as being configured to receive data 301 from a data store 302. In turn, the computing device 320 may respond according to a predetermined response 312-1, 312-2, 314 or 316 to format at least some of the data 301 in a format suitable for rendering to a display. Such formatting may format at least some of the data 301 to render a view, which may be controlled by manipulating the input device 330.

In the example scenarios 302, 304, and 306, the data 301 is at least three-dimensional and capable of being sliced in planes (e.g., orthogonal or non-orthogonal sections). A planar window 303 is also shown in the example scenarios 302, 304 and 306. In the scenario 302, the input device 330 may be manipulated to pan or zoom the window 303 of the data 301 for a slice x_{b}. User input via the device 330 may cause formatting of data for viewing (e.g., rendering to a display) according to a response 312-1 or a response 312-2. For example, the response 312-1 translates movement along a radial line of the device 330 from 90 degrees to 270 degrees (or alternatively tilt toward such angles) to speed in the data 301 along the z-axis of the Cartesian coordinate system of the data 301. For the response 312-2, it translates movement along a radial line of the device 330 from 0 degrees to 180 degrees (or alternatively tilt toward such angles) to speed in the data 301 along the y-axis of the Cartesian coordinate system of the data 301. A user may optionally operate a control that provides for selection of a different coordinate of the data, optionally along a non-orthogonal plane, etc.

In the scenario 304, the input device 330 may be manipulated to move to a different slice xₐ of the data 301. User input via the device 330 may cause formatting of data for viewing (e.g., rendering to a display) according to a response 314. For example, the response 314 translates rotational movement about a rotational axis of the device 330 (e.g., from 0 degrees to 360 degrees) to speed in the data 301 along the x-axis of the Cartesian coordinate system of the data 301. A user may optionally operate a control that provides for selection of a different coordinate of the data, optionally along a non-orthogonal plane, etc.

In the scenario 306, the input device 330 may be manipulated to move to yet another slice x_{c} of the data 301. User input via the device 330 may cause formatting of data for viewing (e.g., rendering to a display) according to a response 316. For example, the response 316 translates rotational movement about a rotational axis of the device 330 (e.g., shown as from 360 degrees to 0 degrees) to speed in the data 301 along the x-axis of the Cartesian coordinate system of the data 301. A user may optionally operate a control that provides for selection of a different coordinate of the data, optionally along a non-orthogonal plane, etc.

As described herein, an input device may be a jog-and-shuttle wheel or dial device configured to output instructions responsive to user input to, for example, control panning and zooming behavior of seismic sections. An input device may provide for direction of panning and zooming and speed. An input device may provide for section slicing (e.g., increasing or decreasing line numbers) and speed and/or the step size in which section number is increased or decreased. The example scenarios of FIG. 3 demonstrate how moving a jog-and-shuttle wheel to the left and right can pan a section to the left and right (e.g., window 303). In such a scenario, moving the control further away from the center axis (e.g., z-axis) of the wheel can cause the speed of the movement to increase (e.g., faster panning).

As described herein, an input device may include a physical wheel or a graphical control wheel where turning the wheel to the right and left can zoom a section in and out. In such an example, how far the wheel is turned from a center null position can determine the speed of the zooming. Referring to the scenario 302 of FIG. 3, zooming may cause a change in the window size. Where a window size becomes smaller, a display may render a close-up view (zoomed-in view) and where a window size becomes larger, a display may render a more distant view (zoomed-out view).

Again, as described in the scenarios 304 and 306 of FIG. 3, turning the wheel to the right or to the left can slice a section to an increasing or decreasing line number (e.g., where line numbers are provided in association with the data 301). In such an example, how far the wheel is turned from a center null position can determine the speed of the slicing.

In the example scenarios 302, 304 and 306 of FIG. 3, the responses 312-1, 312-2, 314 and 316 may be built-in to the device 330, programmed into a computing device (e.g., hardware, software or a combination of hardware and software), or a combination of built-in and programmed. One or more computer-readable media may include processor-executable instructions to instruct a computing device to receive information from an input device and format data to render a view to a display. FIG. 3 shows examples of computer-readable media 313-1, 313-2, 315 and 317, which may include instructions for the respective, corresponding responses 312-1, 312-2, 314 and 316. Such instructions can provide for formatting of data and rendering views responsive to rotational and linear and optionally tilt input. Accordingly, the input device 330 may provide a rotatable wheel and a linear slider capable of navigating views of data (e.g., multidimensional seismic data or other data).

As described herein, one or more computer-readable media can include computer-executable instructions to instruct a computing device to: format multidimensional data, with respect to one or more dimensions of a multidimensional coordinate system, responsive to receipt of a first linear motion signal from manipulation of an input device; format multidimensional data, with respect to one or more dimensions of a multidimensional coordinate system, responsive to receipt of a second linear motion signal from manipulation of an input device where the first linear motion and second linear motion can be or are orthogonal motions; format multidimensional data, with respect to one or more dimensions of a multidimensional coordinate system, responsive to receipt of a first rotational motion signal from manipulation of an input device; and format multidimensional data, with respect to one or more dimensions of a multidimensional coordinate system, responsive to receipt of a second rotational motion signal from manipulation of an input device where the first rotational motion and the second rotational motion can be or are clockwise and counter-clockwise motions. Such one or more computer-readable media can include computer-executable instructions to instruct a computing system to render formatted multidimensional data to a display device and optionally render a graphic to a display device where a characteristic of the graphic depends on a received motion signal. For example, such a graphic may be an arrow and the characteristic may be size, color, etc. With respect to an input device, such a device may be a touch screen or a jog-and-shuttle wheel or other type of device (e.g., optionally with a rotatable wheel).

As described herein, one or more computer-readable media may include computer-executable instructions to instruct a computing system to render a series of views of formatted multidimensional data to a display device at a frame speed dependent upon an extent of motion (e.g., motion due to manipulation of an input device).

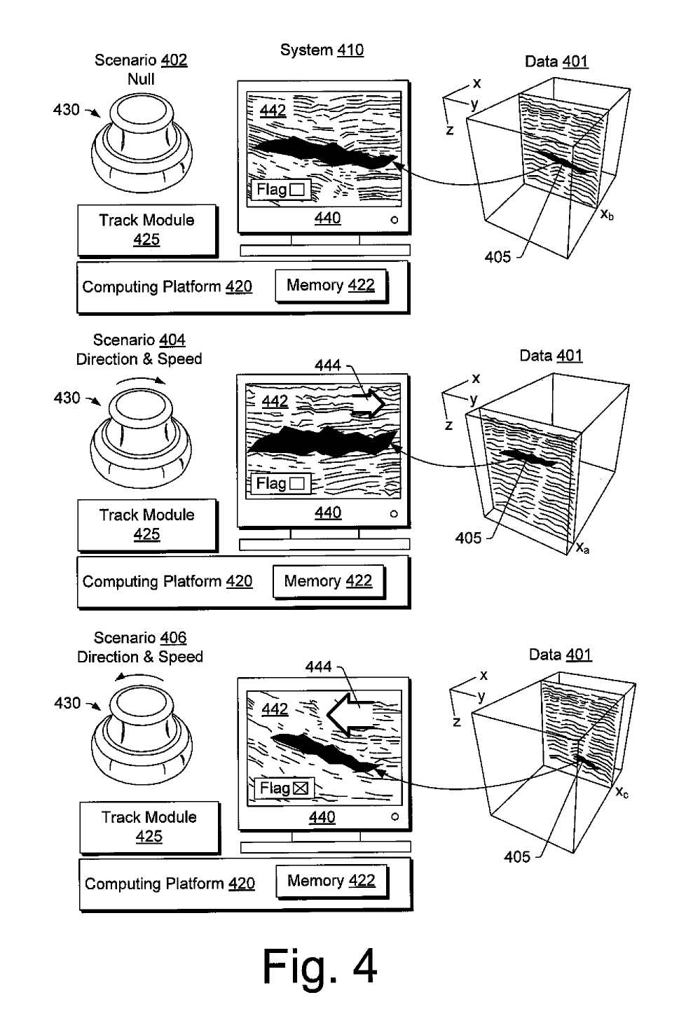

FIG. 4 shows an example of a system 410 and three example scenarios 402, 404 and 406 for formatting at least some data 401. The data 401 is at least three-dimensional and capable of being sliced in planes. A feature 405 of the data 401 is also shown in the example scenarios 402, 404 and 406. The system 410 includes a computing platform 420 with memory 422, a track module 425 (which may be stored in memory 422), an input device 430 and a display 440 where the computing platform 420 allows for formatting and rendering information 442 to the display 440 responsive to input received via the input device 430 and optionally via instructions per the track module 425. Accordingly, a user may manipulate the input device 430, the computing platform 420 may receive a motion signal from the manipulated input device 430 and, in turn, format at least some of the data 401 according to instructions of the track module 425 and ultimately render the formatted data to the display 440 as rendered information 442.

In the scenario 402, the input device 430 may be in a null position as associated with a slice x_{b} of the data 401 that includes the feature 405. As described herein, the track module 425 may allow a user to select the feature 405 for tracking in the data 401.

In the scenario 404, the input device 430 may be manipulated by spinning in a clockwise direction to move to a slice xₐ of the data 401. Where the feature 405 has been selected for tracking, the track module 425 causes the computing platform 420 to track and window the feature 405 for rendering to the display 440 (e.g., by appropriately formatting at least some of the data 401). Further, a graphic 444 may be rendered to the display 440 to indicate direction and speed. For example, the arrow graphic 444 may be sized, colored, etc., such that a user is notified as to how fast navigation is occurring through the data 401 (e.g., larger arrow, darker color or shade indicating faster navigation and smaller arrow, lighter color or shade indicating slower navigation).

In the scenario 406, the device 430 may be manipulated by spinning in a counter-clockwise direction to move to a slice x, of the data 401. Where the feature 405 has been selected for tracking, the track module 425 causes the computing platform 420 to track and window the feature 405 for rendering to the display 440 (e.g., by appropriately formatting at least some of the data 401). Further, as indicated in the scenario 406, a “flag” control may be selected to flag the rendered information 442 of feature 405 for the slice x_{c}. Flagging may cause data, associated information, etc., to be stored to memory (e.g., consider memory 422 of the computing platform 420). In the scenario 406, a log may indicate that a flag was set such that a user may readily return to the data, associated information, etc., for any of a variety of purposes. For example, where a flag is set for a feature relevant to extraction of a resource from a reservoir, information associated with the feature may become readily available for input to a workflow (see, e.g., the workflow component 144 of FIG. 1). In such an example, a workflow component may allow for access to information flagged during a visualization of data (e.g., seismic data, model data, etc.).

As mentioned, the track module 425 may provide for windowing as a form of formatting. As described herein, such windowing may be dynamic and depend on the type of selection made for tracking. For example, where a geologic structure is selected (e.g., as identified by a property, attribute, etc.), the track module 425 may cause the computing platform 420 to analyze the data 401 for boundaries of the structure. In such an example, in turn, boundaries can automatically alter windowing to zoom-in or zoom-out depending on the scale of the structure in various viewing planes. Accordingly, display space can be optimized for a user to visually inspect or otherwise analyze a structure.

In an example where a property limit or range is selected for tracking (e.g., permeability from x₁ to x₂), a track module may perform an analysis to identify a relatively contiguous 3D network within data and allow for rendering of the network to a display (e.g., slice-wise rendering while also showing locations in an accompanying 3D perspective view). As described herein, tracking can include display of a close-up view (e.g., planar view) and an expanded view (e.g., 3D perspective view).

As described herein, formatting of data can include various operations whereby discrete data points in a multidimensional coordinate system are averaged, interpolated, etc. Hence, formatting can include averaging, interpolating or other types of data processing. Formatting optionally includes processing to obtain polygonal data describing a feature (e.g., a horizon or other structure). Formatting optionally includes processing data to determine contours for a section. Formatting can include processing data to obtain polygonal contours and transforming the contours into a multidimensional object (e.g., 3D object).

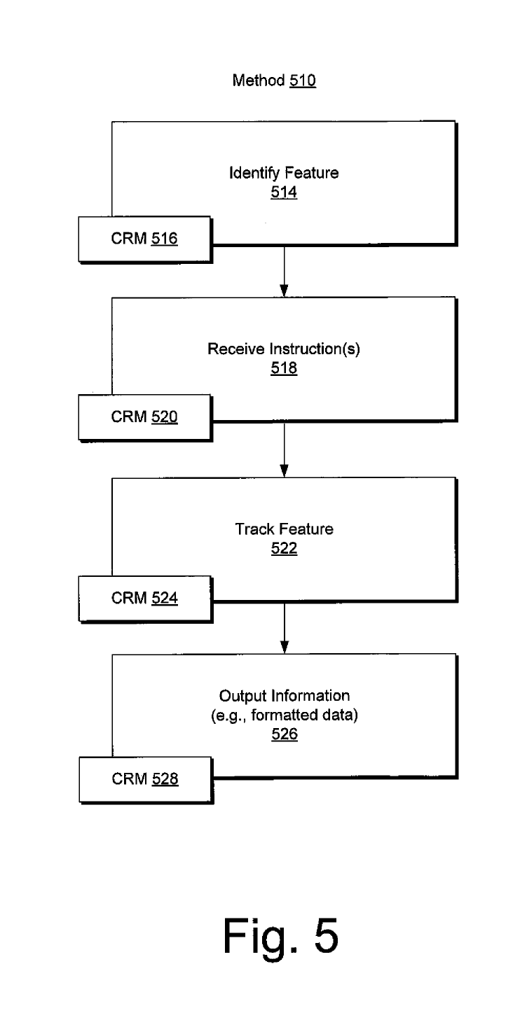

FIG. 5 shows an example of a method 510 for outputting information associated with a tracked feature. In an identification block 514, a feature ascertainable within multidimensional data is identified. A reception block 518 receives instructions for a desired view of the feature. In a track block 522, the feature is tracked within the multidimensional data to provide for the desired view. In an output block 526, information is output sufficient for rendering the track feature for the desired view. For example, a 3D data set may be analyzed for characteristics associated with a feature and a desired view and resulting information output to display memory or other memory (e.g., for printing, viewing, workflow analysis, etc.).

The method 510 of FIG. 5 is shown in association with various computer-readable media blocks 516, 520, 524 and 528. Such blocks generally include instructions suitable for execution by one or more processors (or cores) to instruct a computing device to perform one or more actions. While various blocks are shown, a single medium may be configured with instructions to allow for, at least in part, performance of various actions of the method 510.

As described herein, a method can include identifying a three-dimensional feature in seismic data; receiving one or more instructions responsive to manipulation of an input device, the one or more instructions corresponding to a series of two-dimensional views of the three-dimensional feature in the seismic data; tracking the three-dimensional feature in the seismic data based on the one or more received instructions; and outputting information to render each view of the series of two-dimensional views of the three-dimensional feature in the seismic data. Such a method may include formatting information and outputting formatted information (e.g., where the formatting information includes windowing a three-dimensional feature). A method may include outputting information to render a graphic where the graphic has a characteristic dependent on receipt of one or more instructions responsive to manipulation of an input device and where the graphic indicates a speed of rendering of successive two-dimensional views (e.g., a frame rate or equivalent thereof).

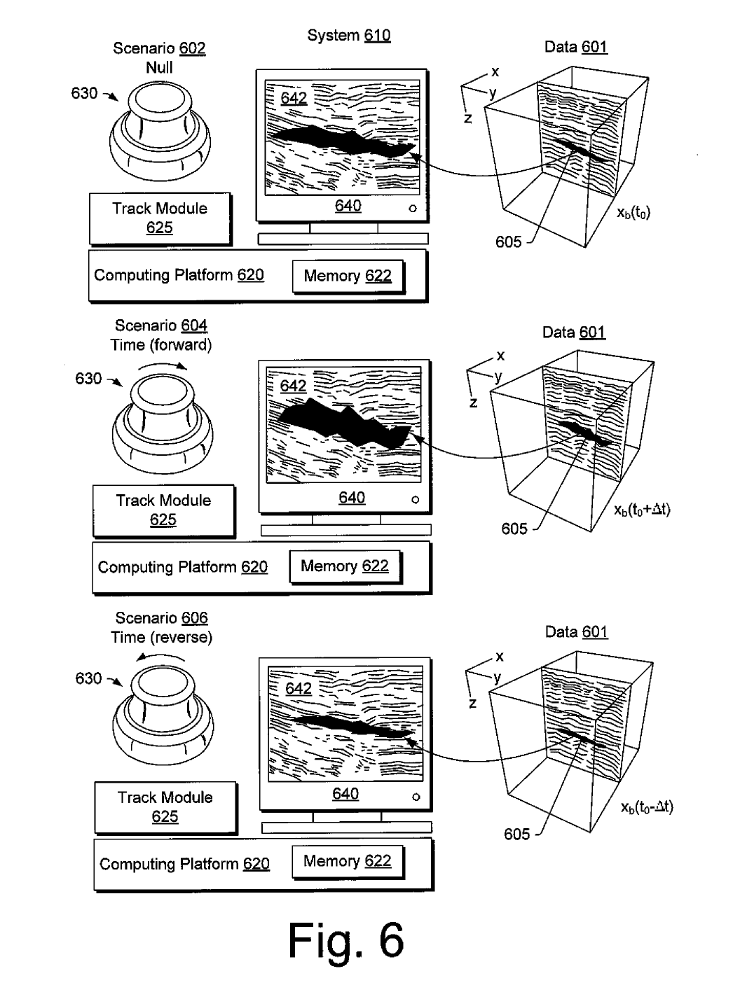

FIG. 6 shows an example of a system 610 and three example scenarios 602, 604 and 606 for manipulating data 601. The data 601 is at least three-dimensional and capable of being sliced in planes. A feature 605 of the data 601 is also shown in the example scenarios 602, 604 and 606. The system 610 includes a computing platform 620 with memory 622, a track module 625, which may be stored in memory 622, an input device 630 and a display 640 where the computing platform 620 allows for rendering information 642 to the display 640 responsive to input received via the input device 630 and optionally via instructions per the track module 625.

In the scenario 602, the input device 630 may be in a null position as associated with a slice x_{b} of the data 601 that includes the feature 605 for a time t₀. As described herein, the track module 625 may allow a user to select the feature 605 for tracking in the data 601, which may include information with respect to time.

In the scenario 604, the input device 630 may be manipulated by spinning in a clockwise direction to move forward in time to a time t₀+Δt of the data 601. In the scenario 606, the input device 630 may be manipulated by spinning in a counter-clockwise direction to move backward in time to a time t₀−Δt of the data 601.

As described herein, a “flag” control may be selected to flag the rendered information 642 of feature 605 for a selected time. Flagging may cause data, associated information, etc., to be stored to memory (e.g., consider memory 622 of the computing platform 620). A log may indicate that a flag was set such that a user may readily return to the data, associated information, etc., for any of a variety of purposes. For example, where a flag is set for a feature relevant to extraction of a resource from a reservoir (e.g., resource pool, network, etc.), information associated with the feature may become readily available for input to a workflow (see, e.g., the workflow component 144 of FIG. 1). In such an example, a workflow component may allow for access to information flagged during a visualization of data (e.g., seismic data, model data, etc.).

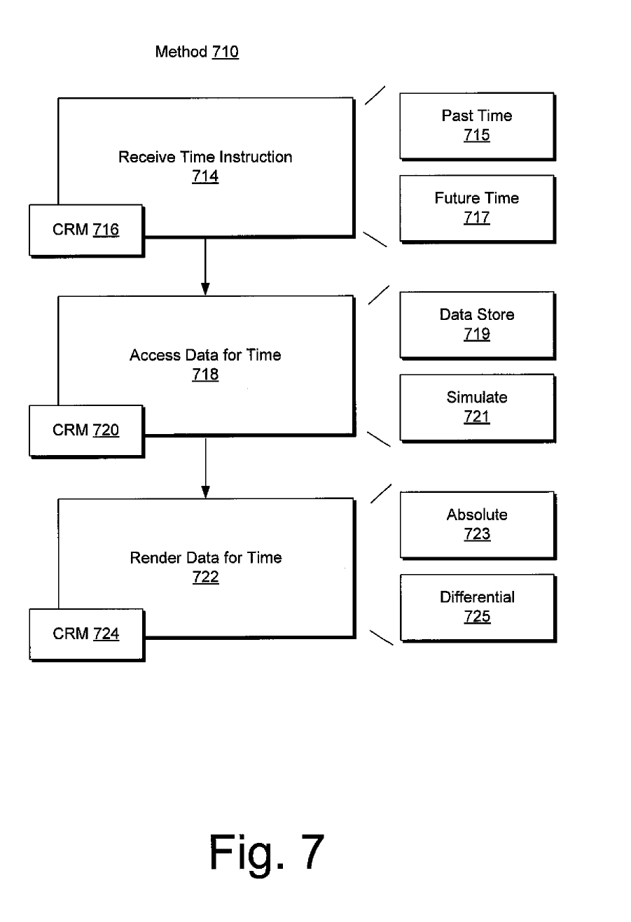

FIG. 7 shows an example of a method 710 for rendering data. In a reception block 714, one or more instructions are received for a desired time, which may be a past time 715 or a future time 717. In an access block 718, data is accessed for the desired time, which may be data from a data store 719 or data from a simulation 721 (e.g., which is performed in response to the received time instruction or instructions). In a render block 722, data at least partially associated with the desired time is rendered to a display. Such data may be absolute data 723 or differential data 725 (e.g., data derived from two or more times).

The method 710 of FIG. 7 is shown in association with various computer-readable media blocks 716, 720 and 724. Such blocks generally include instructions suitable for execution by one or more processors (or cores) to instruct a computing device to perform one or more actions. While various blocks are shown, a single medium may be configured with instructions to allow for, at least in part, performance of various actions of the method 710.

As described herein, one or more computer-readable media can include computer-executable instructions to instruction a computing device to: receive a time instruction for a reservoir model, the instruction responsive to manipulation of an input device wherein a direction of the manipulation determines whether the instruction corresponds to a past time or to a future time; access reservoir model data from a data store responsive to receipt of an instruction that corresponds to a past time or to perform a simulation of a reservoir model and access reservoir model data from the simulation responsive to receipt of an instruction that corresponds to a future time; and render at least some accessed reservoir model data to a display based on receipt of an instruction that corresponds to a past time or receipt of an instruction that corresponds to a future time. One or more computer-readable media can include instructions where a clockwise direction corresponds to a future time and where a counter-clockwise direction corresponds to a past time. One or more computer-readable media can include instructions to render a graphic to a display where a characteristic of the graphic depends on a direction of the manipulation of an input device. While rotational directions are mentioned, linear directions may alternatively be used for time (e.g., consider capabilities that allow user assignment of manipulation features of an input device).

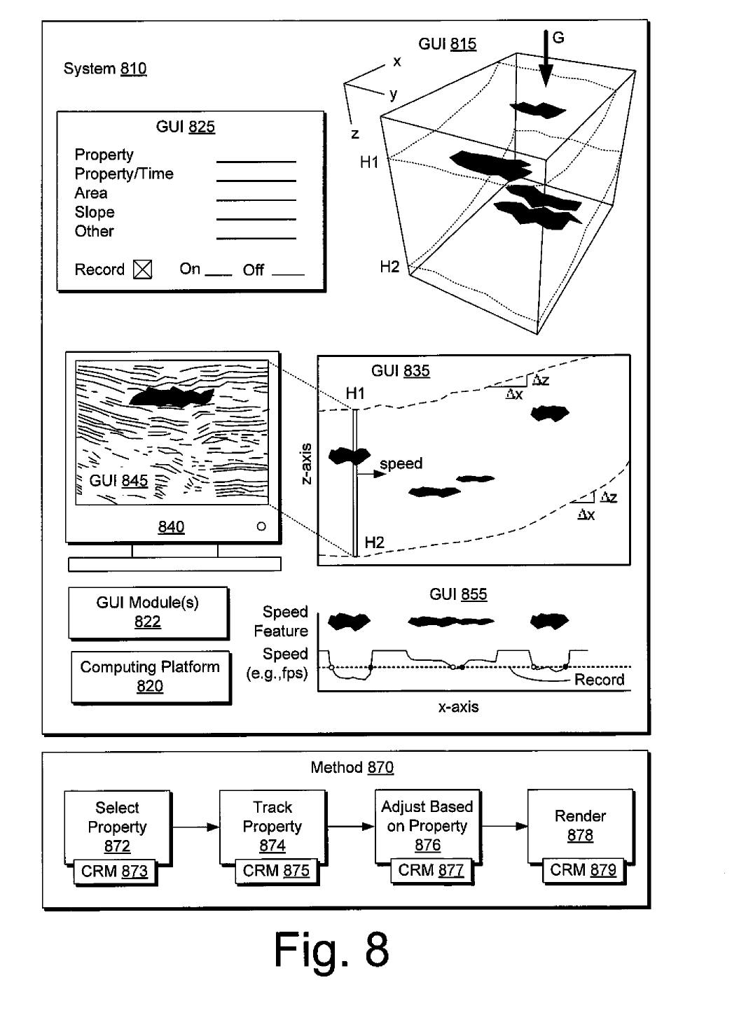

FIG. 8 shows an example of a system 810 and an example of a method 870. The system 810 includes a computing platform 820, graphical user interface modules 822, and a display 840 for presentation of one or more graphical user interfaces. Various examples of graphical user interfaces (GUIs) are shown in FIG. 8, including a perspective GUI 815, a selection GUI 825, a planar GUI 835, a planar GUI 845 and a speed GUI 855.

The GUI 815 shows a 3D perspective view of features in a data set along with direction of acceleration of gravity (G). The GUI 815 shows four isolated structures bound by two horizons (H1 and H2).

The GUI 825 allows a user to select or otherwise enter information for use in tracking, formatting, rendering, etc. A user may select a property (or attribute), a property versus time (e.g., change in property over a period of time), an area (e.g., cross-sectional area), a slope (e.g., optionally with respect to gravity), or other metric (e.g., criteria, property, feature, etc.), which may be a custom metric based on one or more values. Further, the GUI 825 includes a record control, which may cause a particular fly through of a data set to be recorded (e.g., stored to memory, whether via storage of images, graphics instructions, settings, etc.).

The GUIs 835 and 845 may be complimentary. For example, the GUI 845 may be windowed (e.g., sized for display) based on some feature or characteristic displayed via the GUI 835. In the example of FIG. 8, the GUI 845 displays yz-planar slices along x between two horizons (H1 and H2). The speed of the display may depend on one or more factors. For example, the speed may depend on the slope of H1 or H2 or a combination thereof. In another example, illustrated by the GUI 855, the speed depends on a speed feature, which may be a cross-sectional area of the isolated features (solid black). Accordingly, when a progressing yz-plane encounters an isolated feature, the speed decreases. Such a feature may be selected based on a property (or attribute) or one or more other criteria. In such a manner, the computing platform 820 may format and render to the display 840 images at a speed (e.g., according to frames per second or other speed measure) whereby the speed slows down when selected features come into view. Such an approach can automatically allow a user to scan vast geographical stretches of data at high speed and important features in the data at low speed.

Referring again to the GUI 825, the “Record” control optionally includes an “On” setting and an “Off” setting. As indicated in the GUI 855, such settings may relate to speed (or speed feature). Hence, where the speed drops below an “On” setting, recording starts and when the speed rises above an “Off” setting recording stops. In such a manner, recording of selected features of interest may occur automatically and readily allow for review by a user.

The method 870 of FIG. 8 provides for rendering data. In a selection block 872, a property is selected. In a track block 874, the selected property is tracked. In an adjustment block 876, a display parameter (e.g., speed) is adjusted based on the selected, tracked property. A render block 878 provides for rendering information (e.g., formatted information based on multidimensional data), according to the adjusted display parameter.

The method 870 of FIG. 8 is shown in association with various computer-readable media blocks 873, 875, 877 and 879. Such blocks generally include instructions suitable for execution by one or more processors (or cores) to instruct a computing device to perform one or more actions. While various blocks are shown, a single medium may be configured with instructions to allow for, at least in part, performance of various actions of the method 870.

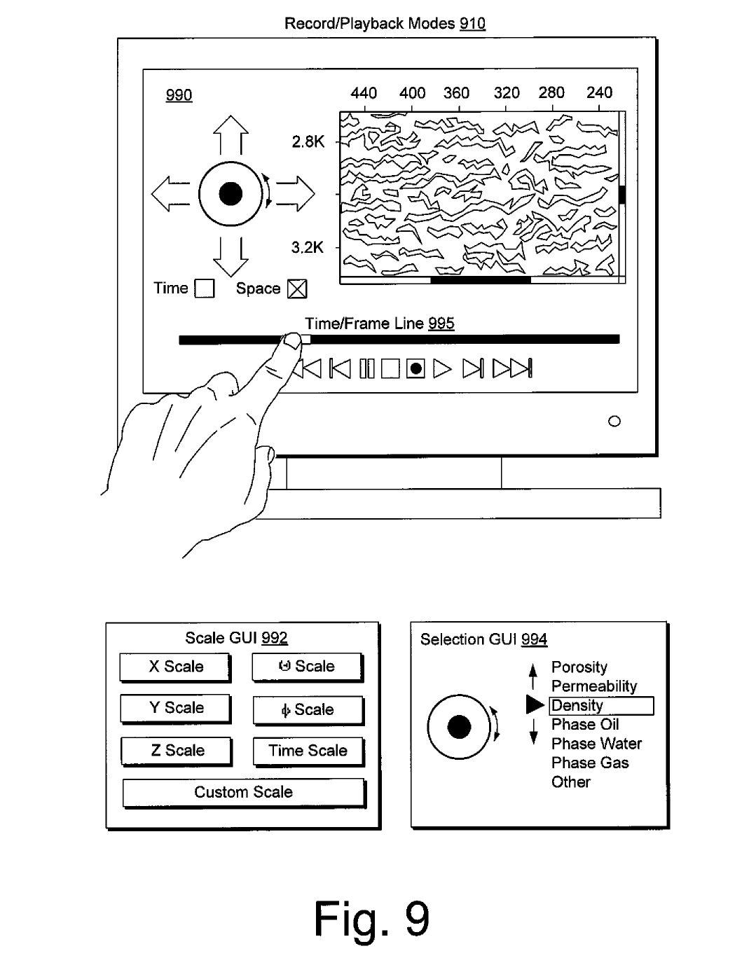

FIG. 9 shows examples of record and playback modes 910 and various example GUIs 990, 992, 994 and 995. The GUI 990 includes a graphic control for input of clockwise or counter-clockwise motions. As indicated by selection blocks, such motions may be associated with time or space. As to time, clockwise motion may move a simulation or data forward in time and counter-clockwise motion backward in time. As to space, a coordinate may be associated with the control to move backward, forward or rotationally. For a structure, the control may allow for tracking (e.g., ant-tracking) of the structure. For example, where the structure is a crack, the control may allow for movement along the crack (e.g., movement along a bound path).

In FIG. 9, the GUI 992 allows for user input to adjust scaling of an input device (see, e.g., example input devices of FIG. 2). Such scaling may relate to Cartesian or other coordinates, including time. A custom scale may be applied, for example, where input from a device is scaled according to a property or other value.

In FIG. 9, the GUI 994 allows for user selection of a property or other parameter. For example, given a view, a user may use such a control to select a property for display. An outer ring may provide for rotational to translational movement to select an item from a list while an inner portion allows for confirmation of a selection of an item from the list.

In FIG. 9, the GUI 995 is a time or frame line that allows a user to navigate time or frames, which may be of a recorded session. Various other controls may be presented to a user and activated by an input device (e.g., mouse, 3D input device, touch screen, etc.).

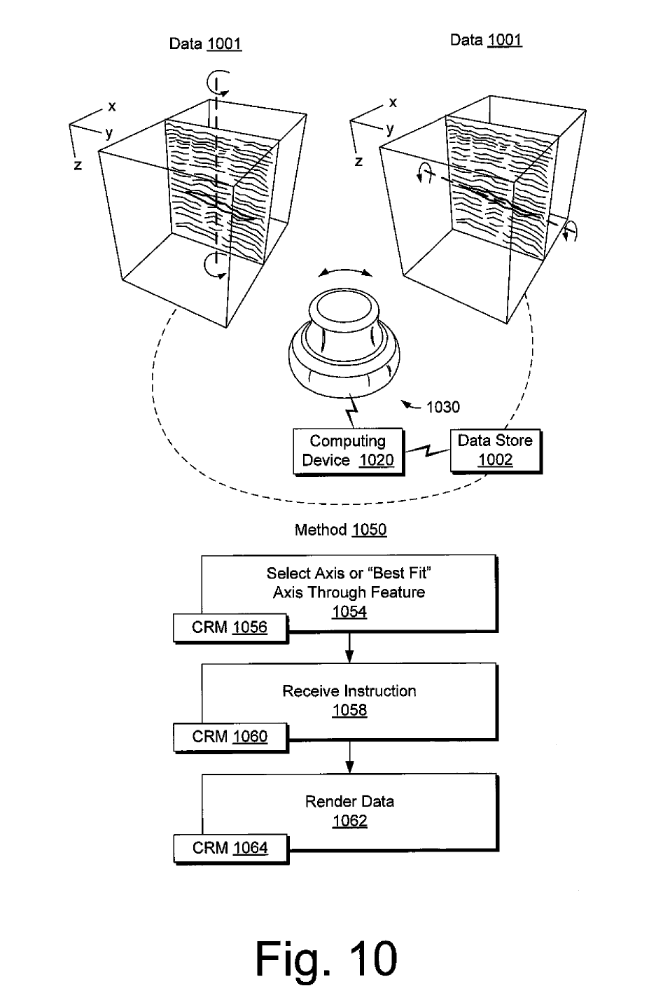

FIG. 10 shows some additional examples of rendering functionalities that may be controlled via an input device 1030 or other input device (e.g., a touch screen, etc.). FIG. 10 shows two scenarios where, for each of the scenarios, a computing device 1020 is shown as being configured to receive motion signals from the input device 1030 as well as being configured to receive data 1001 from a data store 1002. In turn, the computing device 1020 may respond to format at least some of the data 1001 in a format suitable for rendering to a display. Such formatting may format at least some of the data 1001 to render a view, which may be controlled by manipulating the input device 1030.

In the examples of FIG. 10, an axis is selected and views may be rendered for planes intersecting the axis. In one example the axis is along the z-coordinate while in the other example the axis is not aligned with any of the coordinate directions. As described herein, a user may rotate a wheel portion of the input device 1030 to cause rendering of successive planes in either a clockwise or counter-clockwise direction about a selected axis.

An example of a method 1050 is also shown in FIG. 10 that includes a selection block 1054 for selecting an axis, a reception block 1058 for receiving one or more instructions and a render block 1062 for rendering information (e.g., to a display). As to the selecting, selection may occur via a “point and click”, or draw, or other manner. For example, selecting may occur via an algorithm such as a best fit (e.g., least squares, etc.) algorithm that fits a line through a feature. In such an example, the feature may be defined by one or more property values. For example, a user may input a range of porosities that causes a feature to be displayed prominently. A user may input an instruction to cause selection of a contiguous feature (e.g., a feature that spans a distance in at least one direction) and an algorithm may fit a line through the selected contiguous feature. Once fit, rotation of an input device wheel can cause data to be transformed (e.g., formatted) to render planes about the axis. A user may optionally alter what is rendered, for example, by selecting a property, a property range, etc. In such a manner, a user may visually explore a region about a feature of interest. In a particular example, a feature may be a bore well and an axis may be a bore well axis. In such an example, a user may explore a region surrounding the bore well (e.g., by rotating a wheel of an input device).

The method 1050 of FIG. 10 is shown in association with various computer-readable media blocks 1056, 1060 and 1064. Such blocks generally include instructions suitable for execution by one or more processors (or cores) to instruct a computing device to perform one or more actions. While various blocks are shown, a single medium may be configured with instructions to allow for, at least in part, performance of various actions of the method 1050.

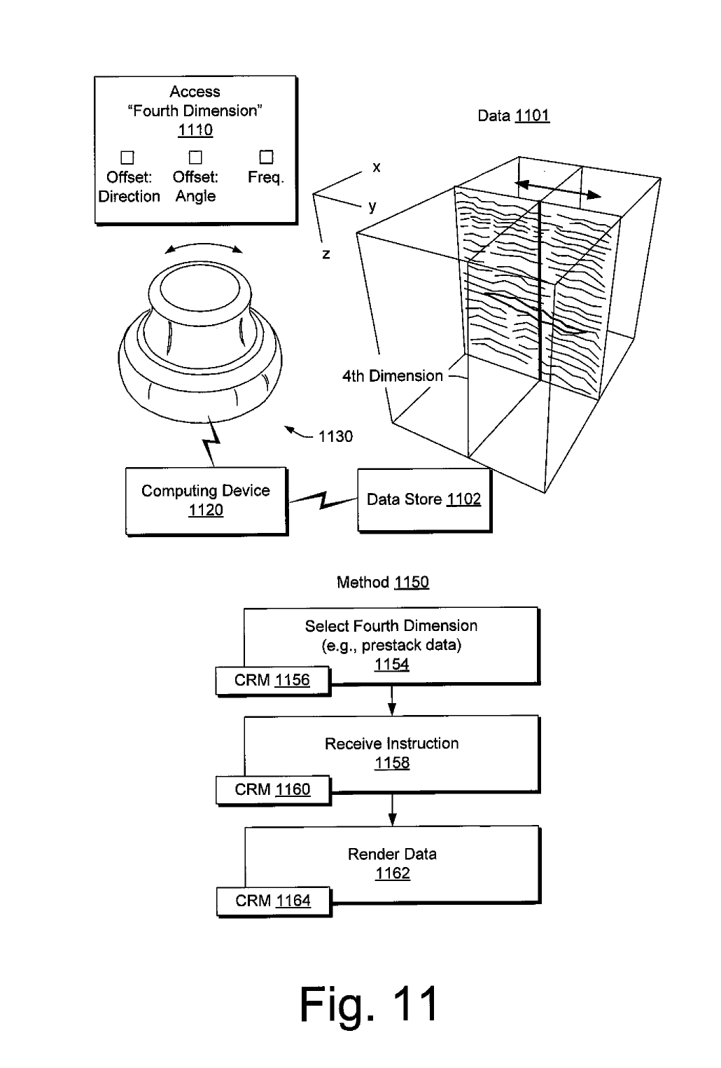

FIG. 11 shows an example of a technique to display a “fourth dimension”. A fourth dimension may be a frequency dimension, an offset dimension or other dimension. A user interface 1110 may display a graphic control that allows a user to select a dimension. For example, the data 1101 may be based on so-called prestack data that spans an offset that can be characterized by a linear dimension (or direction) or an angle. Such data may be considered “raw” data acquired during a seismic exploration of a region that was relied upon to generate data 1101.

As described herein, a 2D plane coming out of a seismic section (a 3D volume with a physical analog) may be used to visualize a fourth dimension. In such an example, at every point in the 3D volume, another “axis” is provided and may be rendered as extending out of a selected portion of the 3D volume or in a separate graphical display (e.g., a separate display window). An input device such as a jog wheel can allow a user to input instructions to render information in the fourth dimension (e.g., by moving a line along a slice in the 3D volume) thus effectively updating the view of the 3D volume with fourth dimension information.

As to an example of a fourth dimension, consider frequency response, which may be rendered as a 2D plane of amplitude and frequency where amplitude values for each point at an intersection may be displayed for 0 to highest frequency. As another example, consider angle as an alternative representation for offset. In general, there are two approaches to look at amplitudes in a prestack data domain: Amplitude Versus Offset (AVO) or Amplitude Versus Angle (AVA). The difference between these two approaches depends on velocity model, such that gathers will look slightly different. As to offset, offset direction or angle domain of the seismic prestack data may be rendered (e.g., values in from zero offset to maximum offset, or zero angle to maximum angle).

An example of a method 1150 is also shown in FIG. 11 that includes a selection block 1154 for selecting a fourth dimension, a reception block 1158 for receiving one or more instructions and a render block 1162 for rendering information (e.g., to a display or to an appropriate memory device suitable for subsequent output for visualization). The method 1150 of FIG. 11 is shown in association with various computer-readable media blocks 1156, 1160 and 1164. Such blocks generally include instructions suitable for execution by one or more processors (or cores) to instruct a computing device to perform one or more actions. While various blocks are shown, a single medium may be configured with instructions to allow for, at least in part, performance of various actions of the method 1150.

As described herein, one or more computer-readable media may include computer-executable instructions to instruct a computing system to output information for controlling a process. For example, such instructions may provide for output to sensing process, an injection process, drilling process, an extraction process, etc. Accordingly, based on visualization, a user may via a graphical control cause a computing device to issue an instruction that results in a physical response in a field (see, e.g, the environment 150 of FIG. 1).

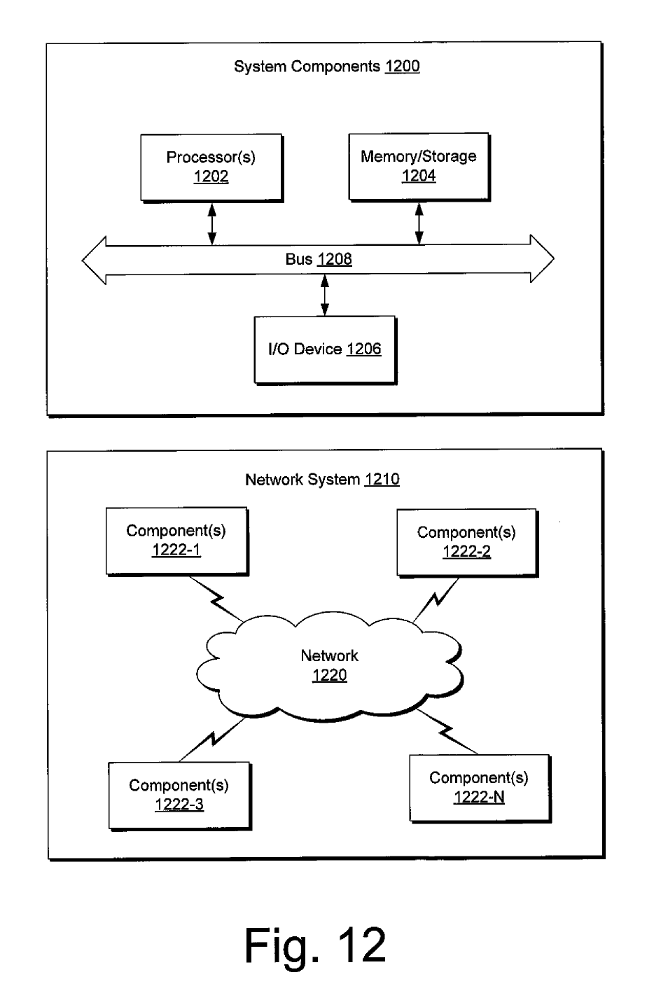

FIG. 12 shows components of a computing system 1200 and a networked system 1210 (e.g., optionally configured to provide for implementation of one or more components of the system 100 of FIG. 1 or aforementioned computing devices or computing platforms). The system 1200 includes one or more processors 1202, memory and/or storage components 1204, one or more input and/or output devices 1206 and a bus 1208. As described herein, instructions may be stored in one or more computer-readable media (e.g., memory/storage components 1204). Such instructions may be read by one or more processors (e.g., the processor(s) 1202) via a communication bus (e.g., the bus 1208), which may be wired or wireless. The one or more processors may execute such instructions to implement (wholly or in part) one or more attributes (e.g., as part of a method). A user may view output from and interact with a process via an I/O device (e.g., the device 1206). As described herein, a computer-readable medium may be a storage component such as a physical memory storage device, for example, a chip, a chip on a package, a memory card, etc.

As described herein, components may be distributed, such as in the network system 1210. The network system 1210 includes components 1222-1, 1222-2, 1222-3, . . . 1222-N. For example, the components 1222-1 may include the processor(s) 1002 while the component(s) 1222-3 may include memory accessible by the processor(s) 1202. Further, the component(s) 1202-2 may include an I/O device for display and optionally interaction with a method. The network may be or include the Internet, an intranet, a cellular network, a satellite network, etc.

### CONCLUSION

Although various methods, devices, systems, etc., have been described in language specific to structural features and/or methodological acts, it is to be understood that the subject matter defined in the appended claims is not necessarily limited to the specific features or acts described. Rather, the specific features and acts are disclosed as examples of forms of implementing the claimed methods, devices, systems, etc.

1. One or more computer-readable media comprising computer-executable instructions to instruct a computing device to:
format multidimensional data, with respect to one or more dimensions of a multidimensional coordinate system, responsive to receipt of a first linear motion signal from manipulation of an input device;
format multidimensional data, with respect to one or more dimensions of a multidimensional coordinate system, responsive to receipt of a second linear motion signal from manipulation of an input device wherein the first linear motion and second linear motion comprise orthogonal motions;
format multidimensional data, with respect to one or more dimensions of a multidimensional coordinate system, responsive to receipt of a first rotational motion signal from manipulation of an input device; and
format multidimensional data, with respect to one or more dimensions of a multidimensional coordinate system, responsive to receipt of a second rotational motion signal from manipulation of an input device wherein the first rotational motion and the second rotational motion comprise clockwise and counter-clockwise motions.

2. The one or more computer-readable media of claim 1 wherein the multidimensional data comprises seismic data.

3. The one or more computer-readable media of claim 1 wherein the multidimensional coordinate system comprises a Cartesian coordinate system.

4. The one or more computer-readable media of claim 1 further comprising computer-executable instructions to instruct a computing system to render formatted multidimensional data to a display device.

5. The one or more computer-readable media of claim 4 further comprising computer-executable instructions to instruct a computing system to render a graphic to a display device wherein a characteristic of the graphic depends on a received motion signal.

6. The one or more computer-readable media of claim 5 wherein the graphic comprises an arrow.

7. The one or more computer-readable media of claim 5 wherein the characteristic comprises size of the graphic.

8. The one or more computer-readable media of claim 5 wherein the characteristic comprises color of the graphic.

9. The one or more computer-readable media of claim 1 wherein the input device comprises a touch screen.

10. The one or more computer-readable media of claim 1 wherein the input device comprises a rotatable wheel.

11. The one or more computer-readable media of claim 1 further comprising computer-executable instructions to instruct a computing system to render a series of views of formatted multidimensional data to a display device at a frame speed dependent upon an extent of motion.

12. A method comprising:
identifying a three-dimensional feature in seismic data;
receiving one or more instructions responsive to manipulation of an input device, the one or more instructions corresponding to a series of two-dimensional views of the three-dimensional feature in the seismic data;
tracking the three-dimensional feature in the seismic data based on the one or more received instructions; and
outputting information to render each view of the series of two-dimensional views of the three-dimensional feature in the seismic data.

13. The method of claim 12 further comprising formatting information and outputting formatted information.

14. The method of claim 13 wherein the formatting information comprises windowing the three-dimensional feature.

15. The method of claim 12 further comprising outputting information to render a graphic wherein the graphic comprises a characteristic dependent on the receiving of the one or more instructions responsive to manipulation of an input device and wherein the graphic indicates a speed of rendering of successive two-dimensional views.

16. One or more computer-readable media comprising computer-executable instructions to instruction a computing device to:
receive a time instruction for a reservoir model, the instruction responsive to manipulation of an input device wherein a direction of the manipulation determines whether the instruction corresponds to a past time or to a future time;
access reservoir model data from a data store responsive to receipt of an instruction that corresponds to a past time or to perform a simulation of a reservoir model and access reservoir model data from the simulation responsive to receipt of an instruction that corresponds to a future time; and
render at least some accessed reservoir model data to a display based on receipt of an instruction that corresponds to a past time or receipt of an instruction that corresponds to a future time.

17. The one or more computer-readable media of claim 16 wherein the input device comprises a rotatable wheel.

18. The one or more computer-readable media of claim 16 wherein a clockwise direction corresponds to a future time and wherein a counter-clockwise direction corresponds to a past time.

19. The one or more computer-readable media of claim 16 wherein the instructions to render comprise instructions to render a graphic to the display wherein a characteristic of the graphic depends on a direction of the manipulation of an input device.

20. The one or more computer-readable media of claim 16 wherein the direction comprises a linear direction.
